(19) United States
(12) Patent Application Publication
(10) Pub. No.: US 2026/0130320 A1
(43) Pub. Date: May 14, 2026

(54) LAWNMOWER BAGGER SYSTEM AND HANDLE

(71) Applicant: Techtronic Cordless GP, Anderson, SC (US)

(72) Inventors: Gregory S. Torrisi, Easley, SC (US); Fernando Vargas, Greenville, SC (US); Michael Carr, Piedmont, SC (US); Matthew Lambert, Seneca, SC (US); Benjamin J. Thomas, Anderson, SC (US); Earnest P. Lane, Easley, SC (US); Jesse J. Jerabek, Easley, SC (US)

(21) Appl. No.: 19/388,686

(22) Filed: Nov. 13, 2025

Related U.S. Application Data
(60) Provisional application No. 63/719,928, filed on Nov. 13, 2024.

(51) Int. Cl. A01D 43/063

(52) U.S. Cl. CPC A01D 43/063

(57) ABSTRACT

Lawnmowers and bagging systems are provided. A lawnmower or bagging system includes a bagger defining a collection chamber; a discharge tube connected to the bagger in upstream fluid communication therewith, the discharge tube comprising an exterior surface and an interior surface defining a tube passage, wherein a guide track is provided on the discharge tube; and a chute collar disposed on the discharge tube, the chute collar comprising a sleeve body extending circumferentially about at least a portion of the exterior surface, and a hand grip extending outward from the sleeve body.

### CROSS-REFERENCE TO RELATED APPLICATIONS

The present application claims priority to U.S. Provisional Patent Application Ser. No. 63/719,928 filed on Nov. 13, 2024, the disclosure of which is incorporated by reference herein in its entirety.

### FIELD

The present disclosure relates generally to lawnmowers, and more particularly for a bagger system for a lawnmower.

### BACKGROUND

Lawnmowers are typically used to trim grass and maintain lawns. Certain lawnmowers provide one or more systems for handling the debris and grass trimmings that mowing actions generate. For instance, many lawnmowers, especially riding lawnmowers, include a collection chamber for containing the trimmings instead of returning them directly to the ground. In order to direct the trimmings to the collection chamber, a discharge duct may be provided. In some lawnmowers, the discharge duct may extend from the mower deck, upwardly and rearwardly to a collection container mounted at or on the rear end of the vehicle.

### BRIEF DESCRIPTION

Although it may be useful to provide a lawnmower or system for guiding grass clippings away from a mower deck, existing designs present of number of drawbacks. For instance, the discharge duct or structures for connecting a mower deck to a separate collection chamber may be required to be exposed to a user outside of the mower frame. In existing systems, this often makes the duct unwieldy for a user or difficult to service. Moreover, many existing systems use a relatively rigid ducting structure. Clogs in particular, may be difficult to see or diagnose. More flexible ducting structures make allow for an easier and varied design process, such as might be adaptable to a wide-range of lawnmowers. Also, flexible ducting structures could reduce the overall required packaging size, which may improve cost and storage. In the past, flexible ducting structures (e.g., tubes) have been unacceptably difficult to maintain or service. For instance, it has been difficult in the past to achieve one-handed removal/installation of the chute, such as to clear a clog from the chute. This has been especially difficult to achieve without creating snag risks on the ducting structures.

Accordingly, improved lawnmowers or bagger systems are desired in the art. In particular, lawnmowers or bagger systems which provide easier user engagement or access would be advantageous (e.g., in the context of a flexible duct).

Aspects and advantages of the present disclosure will be set forth in part in the following description, or may be obvious from the description, or may be learned through practice of the technology.

In accordance with one embodiment, a grass collection unit for a lawnmower is provided. The grass collection unit may include a bagger, a discharge tube, a chute collar, and a chute collar. The bagger may define a collection chamber. The discharge tube may be connected to the bagger in upstream fluid communication therewith. The discharge tube may include an exterior surface and an interior surface defining a tube passage. A guide track may be provided on the discharge tube. The chute collar may be disposed on the discharge tube. The chute collar may include a sleeve body extending circumferentially about at least a portion of the exterior surface, a hand grip extending outward from the sleeve body, and a collar tab disposed in complementary engagement with the guide track to restrict circumferential movement of the chute collar relative to the discharge tube.

In accordance with another embodiment, a lawnmower is provided. The lawnmower may include a frame, a walking element, a propulsion motor, a mower deck, a cutting blade, a bagger, a discharge tube, a chute collar, and a chute collar. The walking element may be coupled to the frame. The propulsion motor may selectively power the walking element. The mower deck may be mounted to the frame. The cutting blade may be rotatably mounted within the mower deck. The bagger may be supported on the frame apart from the mower deck. The bagger may define a collection chamber downstream from the mower deck. The discharge tube may be connected to the bagger in upstream fluid communication therewith. The discharge tube may include an exterior surface and an interior surface defining a tube passage. A guide track may be provided on the discharge tube. The chute collar may be disposed on the discharge tube. The chute collar may include a sleeve body extending circumferentially about at least a portion of the exterior surface, a hand grip extending outward from the sleeve body, and a collar tab disposed in complementary engagement with the guide track to restrict circumferential movement of the chute collar relative to the discharge tube.

In accordance with yet another embodiment, a lawnmower is provided. The lawnmower may include a frame, a walking element, a propulsion motor, a mower deck, a cutting blade, a bagger, a discharge tube, a chute collar, and a chute collar. The walking element may be coupled to the frame. The propulsion motor may selectively power the walking element. The mower deck may be mounted to the frame. The cutting blade may be rotatably mounted within the mower deck. The bagger may be supported on the frame apart from the mower deck. The bagger may define a collection chamber downstream from the mower deck. The discharge tube may be in fluid communication between the mower deck and the bagger and define a tube passage to direct clippings from the mower deck to the bagger. The discharge tube may include a separable flexible portion and rigid portion. The separable rigid portion may be disposed upstream from the separable flexible portion. The chute collar may be disposed on the flexible portion of the discharge tube. The chute collar may include a sleeve body extending circumferentially about at least a portion of the discharge tube to restrict circumferential movement of the chute collar relative to the discharge tube, and a hand grip extending outward from the sleeve body.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 provides a perspective view of a lawnmower in accordance with embodiments of the present disclosure;

FIG. 2 provides a perspective view of a portion of a grass collection unit in accordance with embodiments of the present disclosure;

FIG. 3 provides a perspective view of a portion of a grass collection unit in accordance with embodiments of the present disclosure;

FIG. 4 provides another perspective view of a portion of the exemplary grass collection unit of FIG. 3;

FIG. 5 provides a plan view of one end of the discharge tube and endcap of the exemplary grass collection unit of FIG. 3;

FIG. 6 provides a perspective view of a chute collar of the exemplary grass collection unit of FIG. 3;

FIG. 7 provides a perspective view of a portion of a discharge tube, in isolation, for a grass collection unit in accordance with embodiments of the present disclosure;

FIG. 8 provides a perspective view of a portion of a grass collection unit in accordance with embodiments of the present disclosure;

FIG. 9 provides a perspective view of the discharge tube of the exemplary grass collection unit of FIG. 8;

FIG. 10 provides a perspective view of a chute collar of the exemplary grass collection unit of FIG. 8;

FIG. 11 provides a bottom view of the lawnmower in accordance with embodiments of the present disclosure;

FIG. 12 provides a perspective view of a portion of a discharge tube, in isolation, for a grass collection unit in accordance with embodiments of the present disclosure;

FIG. 13 provides a side perspective view of a portion of a grass collection unit in accordance with embodiments of the present disclosure; and

FIG. 14 provides a top perspective view of the exemplary grass collection unit of FIG. 13.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

In general, the disclosure provides a lawnmower and bagging system with a discharge tube with a chute collar that can be engaged or grabbed by a user. The chute collar may be secured or keyed in place relative to the discharge tube. Notably, this may ensure the chute collar (including a grip thereof) stays in a desired location or orientation relative to the user. Moreover, this may advantageously permit discrete portions or segments of the discharge tube to be selectively separated (e.g., by a user manually pulling apart the segments), which may otherwise be difficult for a user.

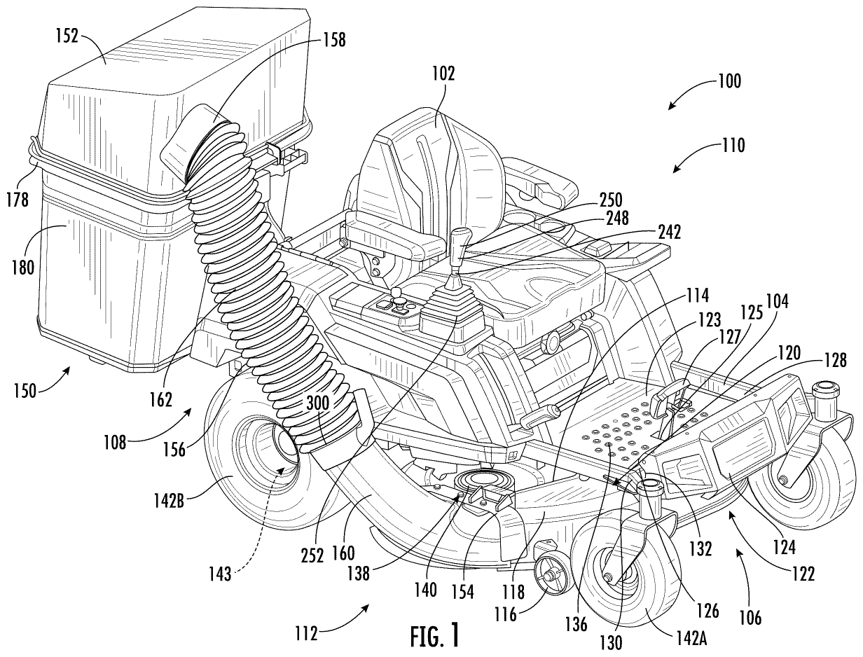

Referring now to the drawings, FIG. 1 illustrates a perspective view of a lawnmower 100 in accordance with an exemplary embodiment of the present disclosure. The lawnmower 100 depicted in FIG. 1 is a riding lawn mower which includes a seat 102 configured to support a lawnmower operator (hereinafter referred to as the “operator”). The seat 102 is coupled to a frame 104 which provides rigidity and structural support to the lawnmower 100. The frame 104 can extend between a front end 106 of the lawnmower 100 and a rear end 108 of the lawnmower 100. The frame 104 can extend between a left side 110 of the lawnmower 100 and a right side 112 of the lawnmower 100. In one or more instances, the frame 104 may extend continuously, i.e., be formed from one or more components connected together. In other instances, the frame 104 can be formed from separate, spaced apart components which are joined through dynamic interfaces.

A mower deck 114 can be disposed at a vertical elevation below the seat 102. The mower deck 114 may also be disposed at least partially in front of the seat 102. At least a portion of the mower deck 114 may also be disposed below at least a portion of the frame 104. The mower deck 114 may be adjustable between a plurality of different heights, as measured relative to an underlying ground surface. For example, the mower deck 114 can be adjustable between at least two different heights, such as at least three different heights, such as at least four different heights, such as at least five different heights, such as at least six different heights, such as at least seven different heights, and so on. The operator can select a desired length of the grass by selecting between the different heights of the mower deck 114.

The mower deck 114 can include one or more walking elements, such as one or more wheels 116. The wheel(s) 116 can be configured to support the mower deck 114 relative to the underlying ground surface at least when the mower deck 114 is at the lowest height, i.e., closest to the underlying ground surface. The wheel(s) 116 may also contact the ground, for example, when the mower deck 114 passes over uneven ground (independent of which height position the mower deck 114 is at). In such instances, the wheels 116 may contact one or more elevated portions of the ground and lift the mower deck 114 relative to the frame 104. This can allow the mower deck 114 to conform to the shape of the underlying ground surface to provide a more even mowing height.

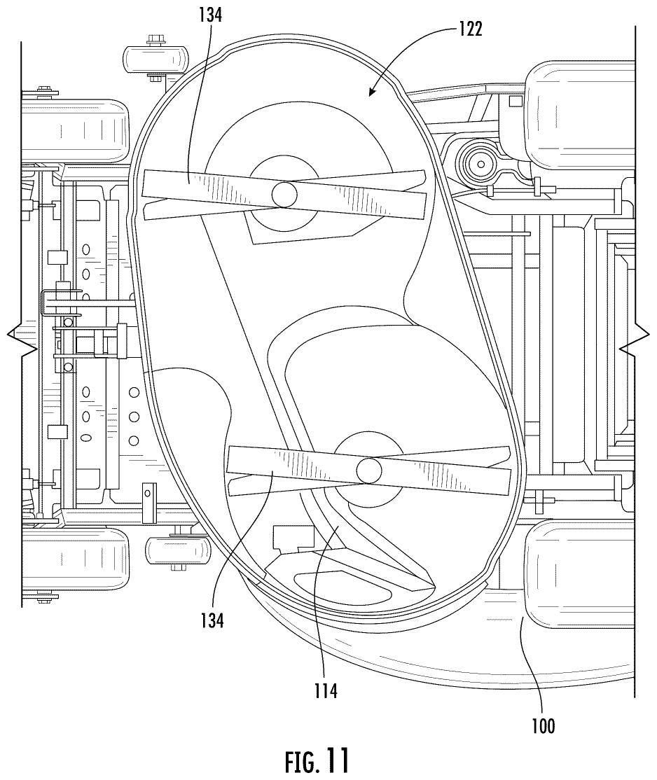

The mower deck 114 can include a body 118 defining an upper surface 120 and a lower surface 122 (FIG. 11). In one or more embodiments, a sound dampening element (not shown) such as a sound dampening material, may be used on the mower deck 114 to reduce the sound created by rotation of the cutting implement. In an embodiment, the sound dampening material can be disposed on the upper surface 120 of the mower deck 114. In another embodiment, the sound dampening material can be disposed on the lower surface 122 of the mower deck 114. In yet another embodiment, the sound dampening material can be disposed between the upper surface 120 and the lower surface 122 of the mower deck 114, e.g., within a cavity defined between the upper and lower surfaces 120 and 122.

By way of non-limiting example, the sound dampening material can include a mass-loaded vinyl sound barrier, acoustic mineral wool insulation, glue compound, one or more resilient sound channels, acoustic caulk, soundproof foam, soundproof blankets or sheets, or the like. In some instances, the sound dampening material can be coupled to the mower deck 114 through adhesive. In other instances, the sound dampening material can be coupled to the mower deck 114 through one or more fasteners, e.g., threaded fasteners.

A floor 123 can be disposed above the mower deck 114. The floor 123 can be coupled with the frame 104. In certain instances, the floor 123 can define a textured surface 136 to enhance grip and increase traction for the operator. In one or more embodiments, the textured surface 136 may be integral with the floor 123. For example, the textured surface 136 can include stamped ridges or frustoconical cutouts in the floor 123. In other embodiments, the textured surface 136 may include a removable or discrete textured component which is coupled with the floor 123.

The floor 123 can include a cutout 125. In an embodiment, the cutout 125 can be defined entirely by the floor 123, i.e., the cutout 125 can be a closed cutout. In another embodiment, the cutout 125 can be a slot which extends into the floor 123 from a side surface of the floor 123, i.e., at least one side of the cutout 125 is open. In certain instances, the cutout 125 can be centrally disposed in a lateral direction of the lawnmower 100. In other instances, the cutout 125 can be laterally offset. A pedal 127 can be disposed at least partially within the cutout 125. The pedal 127 can provide functionality for the operator. For instance, the pedal 127 can be a brake pedal to allow the operator to brake the lawnmower 100. The pedal 127 can include a park feature which allows the operator to selectively reconfigure the lawnmower 100 to a parked mode.

In certain instances, the lawnmower 100 can further include a footrest 124. By way of example, the footrest 124 can extend between and be supported by components of the frame 104. In the depicted embodiment, the frame 104 includes a cross member 126 extending between two lateral members 128 and 130. In one or more embodiments, the footrest 124 can include a groove 132 which receives the cross member 126. In this regard, the footrest 124 can rest upon the cross member 126 and be supported at least in part by the cross member 126. The footrest 124 may also be coupled to the frame 104 at one or more other locations, such as at the lateral members 128 and 130.

The footrest 124 can be disposed at a vertical elevation above the mower deck 114. In the depicted embodiment, the footrest 124 is disposed at the front end 106 of the lawnmower 100. In this regard, the operator can extend his or her feet forward to the footrest 124 for support, e.g., when seated on the lawnmower 100. The footrest 124 may also operate as a fender (or bumper) for the front end 106 of the lawnmower 100. In the event of impact, the footrest 124 can be easily swapped and replaced to reduce the costs associated with damage to the lawnmower 100.

The mower deck 114 can shield the operator from one or more cutting implements 134 (FIG. 11) of the lawnmower 100. In an embodiment, the mower deck 114 can define one or more receiving areas 138 which each house a cutter motor 140. The number of receiving areas 138 and motors 140 can correspond with the number of discrete cutting implements 134 of the lawnmower 100. In a particular embodiment, the lawnmower 100 can include two cutting implements 134 spaced apart from one another in a generally lateral (width) direction. In this regard, the mower deck 114 can include two receiving areas 138 and two motors 140. In another embodiment, the lawnmower 100 can include three cutting implements 134, four cutting implements 134, five cutting implements 134, or even six or more cutting implements 134.

The motors 140 can extend through the mower deck 114 such that a portion of the motors 140 is disposed above the mower deck 114 and another portion of the motors 140 is disposed below the mower deck 114. The motors 140 may be removably coupled to the mower deck 114 to allow easy access for service and repair.

The lawnmower 100 can further include a walking element configured to move the lawnmower 100 over the underlying ground surface. The walking element can include, for example, one or more wheels, treads, or the like. In the depicted embodiment, the lawnmower 100 has four wheels including two front wheels 142A and two rear wheels 142B. Nonetheless, additional or alternative embodiments may include any other suitable number or types of walking elements (e.g., wheels or continuous-track treads), as would be understood.

In an embodiment, the front wheels 142A can be passive. That is, the front wheels 142A may not be actively driven or steered. Instead, the front wheels 142A can passively support the weight of the lawnmower 100, operator, and other features described herein. In an embodiment, the front wheels 142A can be coupled to the frame 104 such that the front wheels 142A rotate about a vertical axis. Rotation of the front wheels 142A about 360 degrees of the vertical axis can permit the lawnmower 100 to turn without incurring a radius of turn. In this regard, the lawnmower 100 can operate as a zero-turn radius (ZTR) lawnmower.

One or both of the rear wheels 142B can be powered (i.e., driven) to propel the lawnmower 100 (e.g., via one or more propulsion motors 143). In an embodiment, the rear wheels 142B can be independently operable, e.g., operated at different speeds as compared to one another. For instance, the rear wheels 142B can be independently powered by separate propulsion motors 143 or operate through interfaces configured to permit different relative displacement between the rear wheels 142B. Examples of such interfaces include slip clutches, gearboxes, and the like. The direction of travel of the lawnmower 100 may be adjusted by varying the speed and direction of each of the rear wheels 142B relative to one another. For instance, the lawnmower 100 can turn left when the right rear wheel 142B is operating faster than the left rear wheel 142B. Conversely, the lawnmower 100 can turn right when the left rear wheel 142B is operating faster than the right rear wheel 142B.

In an embodiment, the front wheels 142A can be different from the rear wheels 142B. For instance, a diameter of the front wheels 142A can be less than a diameter of the rear wheels 142B. By way of another example, tire width of the front wheels 142A can be less than tire width of the rear wheels 142B. By way of yet another example, the front wheels 142A may have a different tread pattern (e.g., a lesser pronounced tread pattern) as compared to the rear wheels 142B.

As shown, the cockpit of the lawnmower 100 can include a user interface 242 which allows the operator to pilot the lawnmower 100. In the illustrated embodiment, the user interface 242 includes a joystick 248 defined by a handle 250 extending from a boot 252. The boot 252 may be sealed relative to at least one of the joystick 248 or handle 250 to prevent ingress of debris into the components of the user interface 242. While the user interface 242 is depicted on a right lateral side of the seat 102, in another embodiment, the user interface 242 can be disposed at a different location within the cockpit, such as on a left lateral side of the seat 102. In one or more embodiments, the user interface 242 can be swappable between the left and right lateral sides of the lawnmower 100. Moreover, further alternative embodiments may provide user interface 242 as or with another suitable interface, such as one or more lap bars, steering wheels, or foot pedal steering implements.

In some embodiments, the lawnmower 100 can include a bagging system 150. The bagging system 150 can include a bagger 152 defining a collection chamber 190 in fluid communication with the mower deck 114 (e.g., downstream therefrom). Optionally, the bagger 152 can be in fluid communication with a discharge chute 154 extending from or within the mower deck 114. Air vortices generated by the cutting implement(s) can generate airflow which propels debris (e.g., grass clippings) from the mower deck 114 to the discharge chute 154. The airflow can further propel the debris to the bagger 152. In such a manner, debris or clippings discharged from the discharge chute 154 of the mower deck 114 can be collected in the bagger 152. Use of the bagging system 150 may be particularly advantageous in certain uses of the lawnmower 100, such as, e.g., during heavy mowing operations when the grass is long, when picking up leaves, or the like.

Generally, the bagger 152 may be spaced apart from the mower deck 114. For instance, bagger 152 may be disposed at the rear end 108 of the lawnmower 100, e.g., behind the seat 102. The bagger 152 may include a support structure 178 configured to engage with the lawnmower 100, e.g., the frame 104 of the lawnmower 100, and support one or more bags 180 of the bagger 152 relative to the lawnmower 100.

In some instances, the bags 180 can be flexible. In other instances, the bags 180 can be relatively rigid (FIG. 1). The term “bag” as used with respect to bags 180 is intended to refer to a vessel defining a volume configured to receive debris and clippings from the discharge chute 154 of the mower deck 114. In an embodiment, the support structure 178 can be integrated into the one or more bags 180 like as shown in FIG. 1. For example, the support structure 178 and one or more bags 180 may be integral with one another, e.g., formed from a rigid plastic. In another embodiment, the support structure 178 can include a relatively rigid structure which retains one or more flexible bags 180.

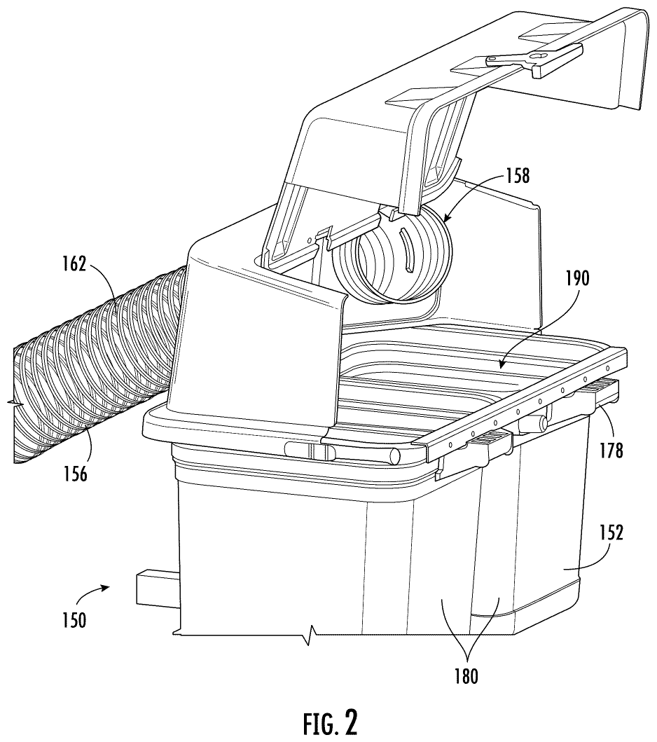

Turning especially to FIGS. 1 and 2, the bagger 152 can further include a cover configured to cover the one or more bags 180 and prevent egress of debris therefrom. In an embodiment, the cover can define the opening 158 in communication with the tube 156. In another embodiment, the opening 158 can be part of another portion of the bagger 152. Optionally, bagger 152 may include a frame defining the collection chamber 190. The collection chamber 190 can be further defined by one or more sidewalls, as seen in FIG. 2. The sidewalls can include one or more sections, such as one section, two sections, three sections, four sections, or the like. The sidewalls can be joined together to enclose the collection chamber 190.

In some embodiments, the bagging system 150 includes a discharge tube 156 extending between the discharge chute 154 (or mower deck 114 generally) and the bagger 152 (e.g., an opening 158 thereof). Specifically, the discharge tube 156 is in fluid communication between the mower deck 114 and the bagger 152. For instance, the discharge tube 156 may include an exterior surface 302 and an interior surface 304 (FIG. 3) defining a tube passage 306 (FIG. 3) to direct debris or clippings from the mower deck to the bagger 152.

In accordance with one or more embodiments, the tube 156 may include a plurality of discrete segments or components linked together. For example, the tube 156 may include multiple portions joined together, such as a first portion 160 and a second portion 162. In the illustrated embodiments, the first portion 160 is coupled with the mower deck 114 (e.g., directly or at the discharge chute 154) and the second portion 162 extends between the first portion 160 and the opening 158 of the bagger 152. In certain embodiments, the multiple portions include a discrete flexible portion (e.g., manually deformable and resilient, such as for a corrugated polymer conduit) and a discrete rigid portion (e.g., relatively stiff or inelastic in comparison to the flexible portion), each of which is selectively or separably joined to the other. As shown, the flexible portion may be provided at or as the second portion 162 while the rigid portion may be provided at or as the first portion 160. In turn, the separable rigid portion 160 is disposed upstream from the separable flexible portion 162.

As will be described in greater detail below, a guide track 308 may be provided at the exterior surface 302 and thus outside of the tube passage 306. Optionally, the guide track 308 may be formed as a molded structure of the chute collar 300. Additionally or alternatively, a negative or correlated shape of the guide track 308 may be formed at the interior surface of the tube passage 306.

In some embodiments, a chute collar 300 having a hand grip 312 is disposed on the discharge tube 156. For instance, the chute collar 300 may be disposed on the rigid first portion 160, as shown. As shown, the chute collar 300 may further include a sleeve body 314. The chute collar 300 may additionally or alternatively include a collar tab 316. Generally, the sleeve body 314 extends (e.g., circumferentially) about at least a portion of the exterior surface 302. Optionally, a compressive or friction fit between the sleeve body 314 and the discharge tube 156 may restrict circumferential movement of the chute collar 300 relative to the discharge tube 156. The hand grip 312 may extend outward from the sleeve body 314 (e.g., radially outward and axially, parallel to an axis defined by the passage 306 as a free-end lever). The collar tab 316 may extend from a portion of the sleeve body 314 to engage with the guide track 308. As will be described in greater detail below, the chute collar 300 may (e.g., selectively) engage with and be operably fixed relative to at least a portion of discharge tube 156. Advantageously, the chute collar 300—and hand grip 312 thereof—may be maintained in a desired position relative to the operator or user. Additionally or alternatively, the chute collar 300 may facilitate leverage for the operator when moving or separating portions of the discharge tube 156.

In optional embodiments, the chute collar 300 may join or hold discrete portions of the tube 156 together. For instance, an inner ring 318 and (e.g., concentric) outer ring 320 may be provided with sleeve body 314. As shown, inner ring 318 may be disposed radially inward from outer ring 320. A connection wall may extend (e.g., radially) between the inner ring 318 and outer ring 320. When assembled, inner ring 318 may be held against or proximal to exterior surface 302. In some such embodiments, one or more ridge teeth 322 are provided. Such ridge teeth 322 may, for instance, extend radially inward from outer ring 320 (e.g., while remaining radially spaced apart from inner ring 318. The ridge teeth 322 may, in turn, define one or more open guide paths within which portions of another portion (e.g., first portion) may be received. If flexible portion 162 is provided as or includes a corrugated tube body (as illustrated), corrugated ridges of the same may be (e.g., threadably) received and secured by the ridge teeth 322, thereby restricting axial movement or separation of the axially adjacent portions 160, 162.

Additionally or alternatively, the first and second portions 160 and 162 can be coupled together at an interface through one or more fasteners, hooks, clamps, straps, or the like. In some such embodiments, a friction fit is formed between the flexible portion 162 and an inner surface of the chute collar 300. For instance, a single ridge tooth may receive and hold a segment of the flexible portion 162 therein, such as to slide or stretch over a corrugated ridge, to secure the position of the chute collar 300 relative to the flexible portion 162.

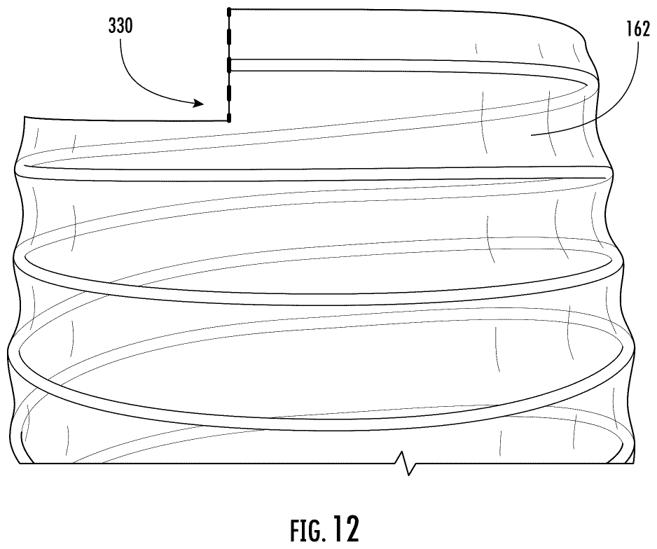

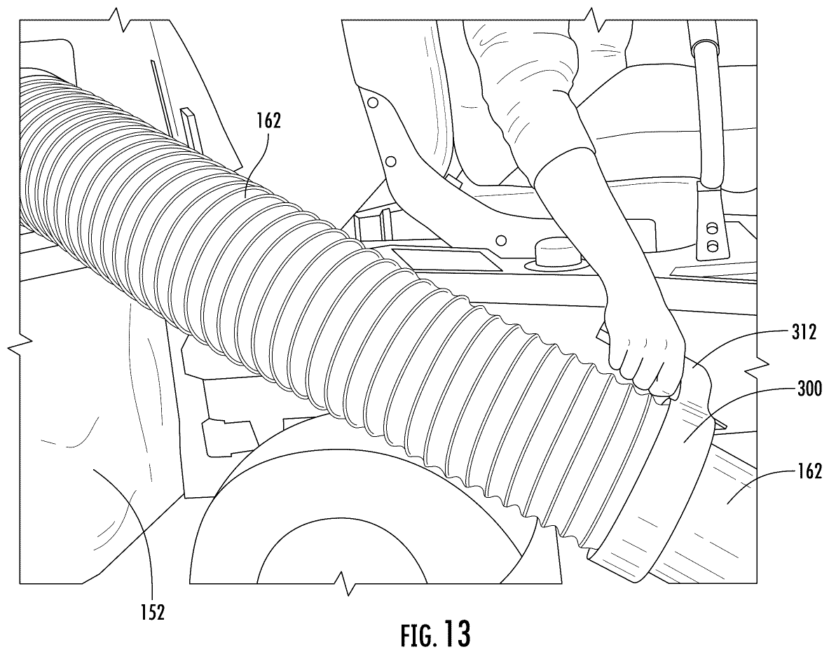

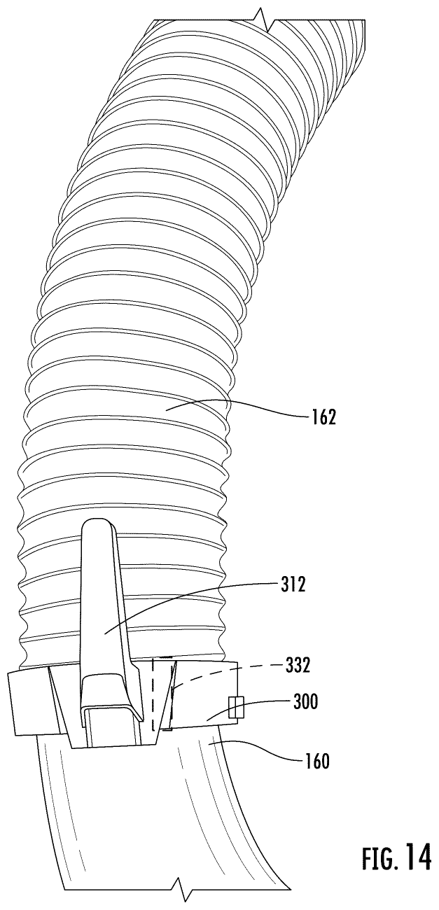

Turning briefly to FIGS. 12 through 14, further additional or alternative embodiments may provide a slidable or rotatable alignment set between the flexible portion 162 and the chute collar 300. In some such embodiments, flexible portion 162 defines an axial blunt edge 330 at an axial end thereof (e.g., proximal to the chute collar 300 or distal to the bagger 152). Optionally, the axial blunt edge 330 may be formed, at least in part, by a helical corrugated ridge or wire frame of the flexible portion, similar to a terminal end of a threaded interface. A complementary stop 332 may be provided on the chute collar 300. For instance, the complementary stop 332 may extend radially inward from an inner surface of the chute collar 300 to engage or rest against axial blunt edge 330. The axial blunt edge 330 and the complementary stop 332 may be axially or circumferentially aligned. In turn, joining or connecting the flexible portion 162 to the chute collar 300 may include moving (e.g., rotating or axially sliding) the chute collar 300 along the flexible portion (or vice versa) until the complementary stop 332 rests against the axial blunt edge. Notably, the flexible portion may be a rotationally rigid member, thereby permitting a predetermined alignment and positioning of the chute collar 300 (e.g., hand grip 312) relative to the flexible portion 162 and rigid portion 160.

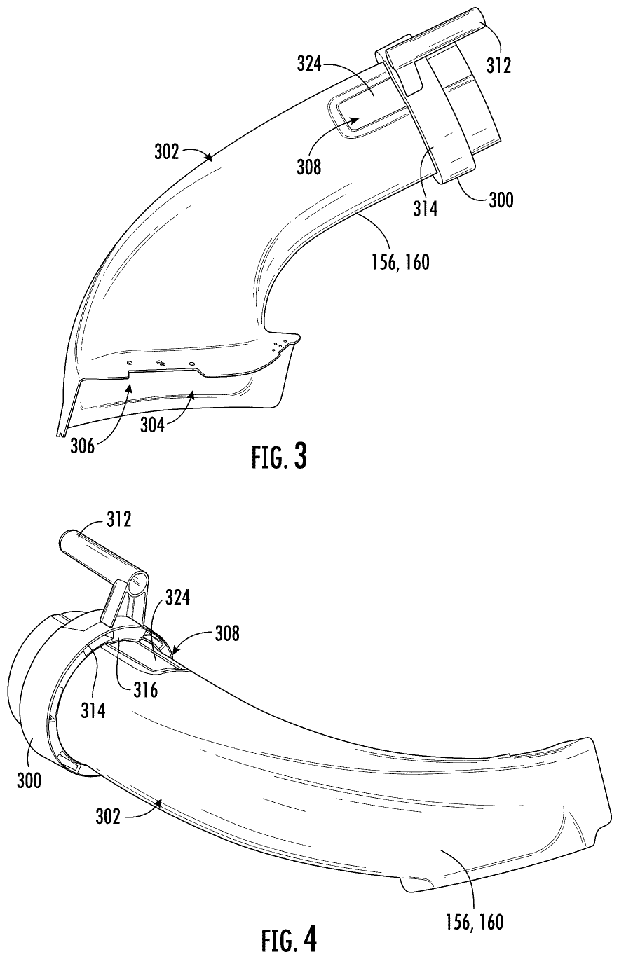

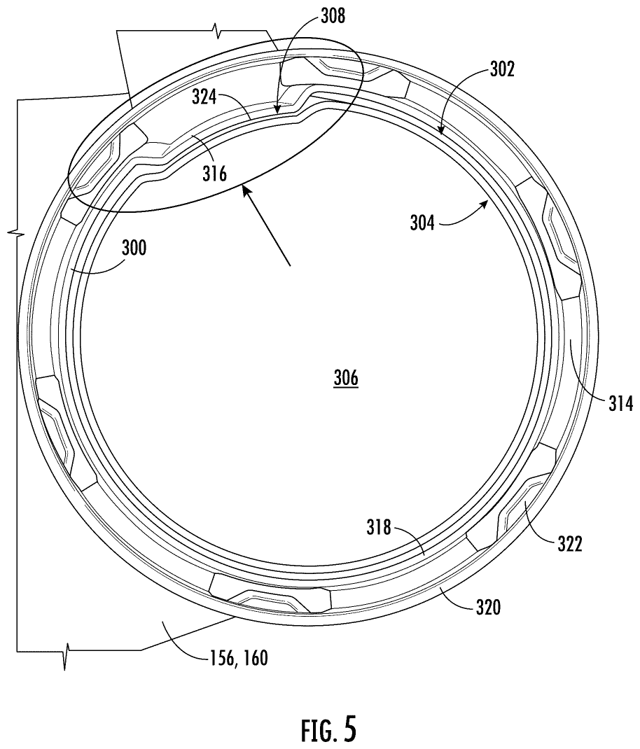

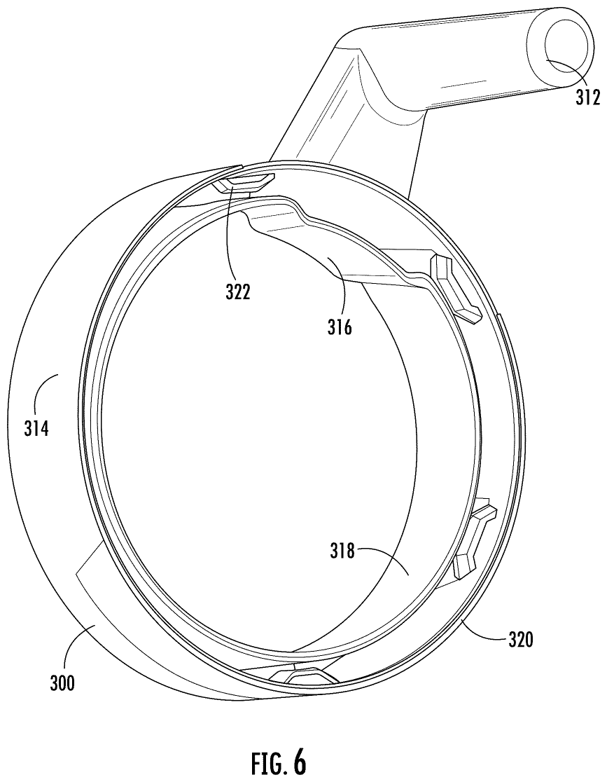

Turning now to FIGS. 3 through 7, certain embodiments include a chute collar 300 on the discharge tube 156, as noted above. The chute collar 300 may be, for instance, slidably disposed on the discharge tube 156. The sleeve body 314 may extend circumferentially about at least a portion of the exterior surface 302 (e.g., as a complete or partial ring about discharge tube 156). Securing the chute collar 300 on the discharge tube 156 may include sliding the sleeve body 314 (e.g., axially) along a segment of the discharge tube 156, such as along a downstream section of the discharge tube 156. Nonetheless, when disposed on the discharge tube 156, the chute collar 300 may be generally fixed in place relative to the discharge tube 156. In particular, the chute collar 300 may be restricted from rotating or moving circumferentially relative to the discharge tube 156. For instance, the collar tab 316 may contact or be cradled within the guide track 308 (e.g., in complementary engagement therewith). The guide track 308 itself may be defined on the rigid portion 160. In turn, the chute collar 300 may be supported on the rigid portion 160.

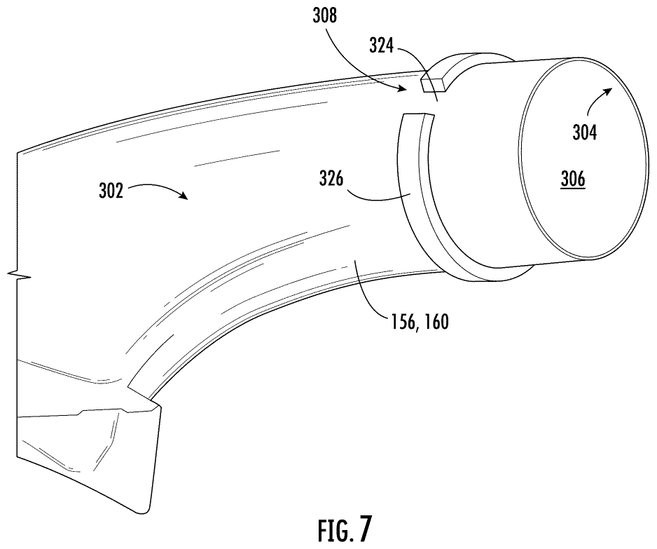

In some embodiments, the guide track 308 may include or be defined as a negative channel 324. The negative channel 324 may be approximately the same size (e.g., along a circumferential direction) as the collar tab 316 and complementary to at least a portion of the same. Thus, the negative channel 324 may provide a circumferentially and axially extending void relative to the exterior surface 302. As shown in FIGS. 3 through 5, the negative channel 324 may be formed by the exterior surface 302. The exterior surface 302 may, for instance, provided a negative embossing extending radially inward from an outer diameter defined by circumferentially adjacent portions of the exterior surface 302. Alternatively, and as shown in FIG. 7, the negative channel 324 may be formed or defined by a track collar 326. In particular, track collar 326 may be fixed on exterior surface 302 (e.g., via one or more adhesives or mechanical fasteners) and circumferentially about a portion thereof. The negative channel 324 may be defined as a circumferential gap between separate ends of the track collar 326.

Returning generally to FIGS. 3 through 7, the collar tab 316 may be received within the negative channel 324. For instance, the collar tab 316 may extend radially inward from the sleeve body 314 (e.g., at the inner ring 318). The collar tab 316 may include a pair of lateral shoulders that may fit against (e.g., in direct bounded contact with) corresponding walls of the negative channel 324. Thus, circumferential movement of the collar tab 316 (and chute collar 300 generally) relative to the negative channel 324 may be prevented or otherwise restricted.

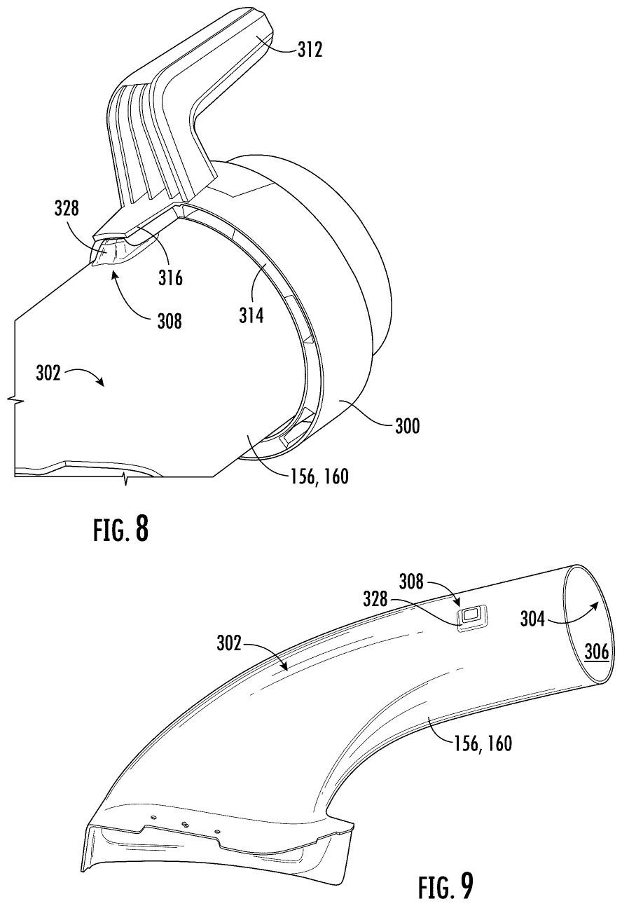

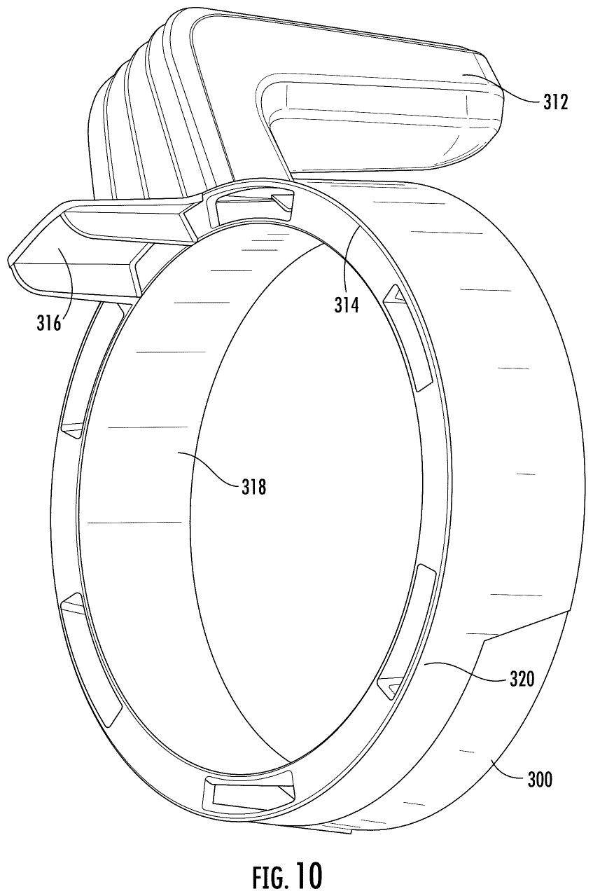

Turning now to FIGS. 8 through 10, certain alternative embodiments may also include a chute collar 300 on the discharge tube 156, as noted above. The chute collar 300 may be, for instance, slidably disposed on the discharge tube 156. The sleeve body 314 may extend circumferentially about at least a portion of the exterior surface 302 (e.g., as a complete or partial ring about discharge tube 156). Securing the chute collar 300 on the discharge tube 156 may include sliding the sleeve body 314 (e.g., axially) along a segment of the discharge tube 156, such as along a downstream section of the discharge tube 156. Nonetheless, when disposed on the discharge tube 156, the chute collar 300 may be generally fixed in place relative to the discharge tube 156. In particular, the chute collar 300 may be restricted from rotating or moving circumferentially relative to the discharge tube 156. For instance, the collar tab 316 may contact, cradle, or cup the guide track 308 (e.g., in complementary engagement therewith). The guide track 308 itself may be defined on the rigid portion 160. In turn, the chute collar 300 may be supported on the rigid portion 160.

In some embodiments, the guide track 308 may include or be defined as a positive rib 328 extending radially upward or outward relative from circumferentially adjacent portions of the sleeve body 314. The positive rib 328 may be approximately the same size (e.g., along a circumferential direction) as the collar tab 316 and complementary to at least a portion of the same (e.g., a recess or groove thereof). Thus, the positive rib 328 may provide a circumferentially and axially extending extrusion relative to the rest of exterior surface 302. As shown, the positive rib 328 may be formed by the exterior surface 302. The exterior surface 302 may, for instance, provide a positive embossing extending radially outward from an outer diameter defined by circumferentially adjacent portions of the exterior surface 302. Alternatively, and as would be understood, the positive rib 328 may be formed or defined by an attached button or mass fixed on exterior surface 302 (e.g., via one or more adhesives or mechanical fasteners).

When assembled, the collar tab 316 may fit on or over the positive rib 328. For instance, the collar tab 316 may extend axially (e.g., axially rearward) from the sleeve body 314 (e.g., at the inner ring 318). The collar tab 316 may include a free end (e.g., opposite a fixed lever end proximal to the sleeve body 314). Additionally or alternative, the collar tab 316 may include an elastic body. In optional such embodiments, the collar tab 316 can deflect (e.g., radially outward) relative to sleeve body 314 while sliding (e.g., axially) over the positive rib 328 for assembly. As shown, the collar tab 316 may include a pair of lateral walls that may fit against (e.g., in direct bounding or cupping contact with) corresponding shoulders of the positive rib 328. Thus, circumferential movement of the collar tab 316 (and chute collar 300 generally) relative to the negative channel 324 may be prevented or otherwise restricted.

Further aspects of the disclosure are provided by one or more of the following embodiments:

Embodiment 1. A grass collection unit for a lawnmower, the grass collection unit comprising: a bagger defining a collection chamber; a discharge tube connected to the bagger in upstream fluid communication therewith, the discharge tube comprising an exterior surface and an interior surface defining a tube passage, wherein a guide track is provided on the discharge tube; and a chute collar disposed on the discharge tube, the chute collar comprising a sleeve body extending circumferentially about at least a portion of the exterior surface, a hand grip extending outward from the sleeve body, and a collar tab disposed in complementary engagement with the guide track to restrict circumferential movement of the chute collar relative to the discharge tube.

Embodiment 2. The grass collection unit of any one or more of the embodiments, wherein the guide track defines a negative channel within which the collar tab is received.

Embodiment 3. The grass collection unit of any one or more of the embodiments, wherein the negative channel is formed by the exterior surface.

Embodiment 4. The grass collection unit of any one or more of the embodiments, wherein the chute collar further comprises a track collar disposed on the exterior surface, the track collar defining the negative channel.

Embodiment 5. The grass collection unit of any one or more of the embodiments, wherein the collar tab extends radially inward from the sleeve body within the negative channel.

Embodiment 6. The grass collection unit of any one or more of the embodiments, wherein the guide track comprises a positive rib extending radially upward from the exterior surface.

Embodiment 7. The grass collection unit of any one or more of the embodiments, wherein the collar tab extends axially from the sleeve body for engagement with the positive rib.

Embodiment 8. The grass collection unit of any one or more of the embodiments, wherein the collar tab cups the positive rib therein and on top of the guide track.

Embodiment 9. The grass collection unit of any one or more of the embodiments, wherein the chute collar is slidably received on the discharge tube.

Embodiment 10. The grass collection unit of any one or more of the embodiments, wherein the discharge tube comprises a separable flexible portion and rigid portion, wherein the separable rigid portion is disposed upstream from the separable flexible portion, and wherein the chute collar is supported on the rigid portion.

Embodiment 11. A lawnmower comprising: a frame; a walking element coupled to the frame; a propulsion motor selectively powering the walking element; a mower deck mounted to the frame; a cutting blade rotatably mounted within the mower deck; a bagger supported on the frame apart from the mower deck, the bagger defining a collection chamber downstream from the mower deck; a discharge tube in fluid communication between the mower deck and the bagger, the discharge tube comprising an exterior surface and an interior surface defining a tube passage to direct clippings from the mower deck to the bagger, wherein a guide track is provided on the discharge tube; and a chute collar disposed on the discharge tube, the chute collar comprising a sleeve body extending circumferentially about at least a portion of the exterior surface, a hand grip extending outward from the sleeve body, and a collar tab disposed in complementary engagement with the guide track to restrict circumferential movement of the chute collar relative to the discharge tube.

Embodiment 12. The lawnmower of any one or more of the embodiments, wherein the guide track defines a negative channel within which the collar tab is received.

Embodiment 13. The lawnmower of any one or more of the embodiments, wherein the negative channel is formed by the exterior surface.

Embodiment 14. The lawnmower of any one or more of the embodiments, wherein the chute collar further comprises a track collar disposed on the exterior surface, the track collar defining the negative channel.

Embodiment 15. The lawnmower of any one or more of the embodiments, wherein the collar tab extends radially inward from the sleeve body within the negative channel.

Embodiment 16. The lawnmower of any one or more of the embodiments, wherein the guide track comprises a positive rib extending radially upward from the exterior surface.

Embodiment 17. The lawnmower of any one or more of the embodiments, wherein the collar tab extends axially from the sleeve body for engagement with the positive rib.

Embodiment 18. The lawnmower of any one or more of the embodiments, wherein the collar tab cups the positive rib therein and on top of the guide track.

Embodiment 19. The lawnmower of any one or more of the embodiments, wherein the chute collar is slidably received on the discharge tube.

Embodiment 20. A lawnmower comprising: a frame; a walking element coupled to the frame; a propulsion motor selectively powering the walking element;
a mower deck mounted to the frame; a cutting blade rotatably mounted within the mower deck; a bagger supported on the frame apart from the mower deck, the bagger defining a collection chamber downstream from the mower deck; a discharge tube in fluid communication between the mower deck and the bagger and defining a tube passage to direct clippings from the mower deck to the bagger, the discharge tube comprising a separable flexible portion and rigid portion, wherein the separable rigid portion is disposed upstream from the separable flexible portion; and a chute collar disposed on the flexible portion of the discharge tube, the chute collar comprising a sleeve body extending circumferentially about at least a portion of the discharge tube to restrict circumferential movement of the chute collar relative to the discharge tube, and a hand grip extending outward from the sleeve body.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A grass collection unit for a lawnmower, the grass collection unit comprising:
a bagger defining a collection chamber;
a discharge tube connected to the bagger in upstream fluid communication therewith, the discharge tube comprising an exterior surface and an interior surface defining a tube passage, wherein a guide track is provided on the discharge tube; and
a chute collar disposed on the discharge tube, the chute collar comprising
a sleeve body extending circumferentially about at least a portion of the exterior surface,
a hand grip extending outward from the sleeve body, and
a collar tab disposed in complementary engagement with the guide track to restrict circumferential movement of the chute collar relative to the discharge tube.

2. The grass collection unit of claim 1, wherein the guide track defines a negative channel within which the collar tab is received.

3. The grass collection unit of claim 2, wherein the negative channel is formed by the exterior surface.

4. The grass collection unit of claim 2, wherein the chute collar further comprises a track collar disposed on the exterior surface, the track collar defining the negative channel.

5. The grass collection unit of claim 2, wherein the collar tab extends radially inward from the sleeve body within the negative channel.

6. The grass collection unit of claim 1, wherein the guide track comprises a positive rib extending radially upward from the exterior surface.

7. The grass collection unit of claim 6, wherein the collar tab extends axially from the sleeve body for engagement with the positive rib.

8. The grass collection unit of claim 6, wherein the collar tab cups the positive rib therein and on top of the guide track.

9. The grass collection unit of claim 1, wherein the chute collar is slidably received on discharge tube.

10. The grass collection unit of claim 1, wherein the discharge tube comprises a separable flexible portion and rigid portion, wherein the separable rigid portion is disposed upstream from the separable flexible portion, and wherein the chute collar is supported on the rigid portion.

11. A lawnmower comprising:
a frame;
a walking element coupled to the frame;
a propulsion motor selectively powering the walking element;
a mower deck mounted to the frame;
a cutting blade rotatably mounted within the mower deck;
a bagger supported on the frame apart from the mower deck, the bagger defining a collection chamber downstream from the mower deck;
a discharge tube in fluid communication between the mower deck and the bagger, the discharge tube comprising an exterior surface and an interior surface defining a tube passage to direct clippings from the mower deck to the bagger, wherein a guide track is provided on the discharge tube; and
a chute collar disposed on the discharge tube, the chute collar comprising
a sleeve body extending circumferentially about at least a portion of the exterior surface,
a hand grip extending outward from the sleeve body, and
a collar tab disposed in complementary engagement with the guide track to restrict circumferential movement of the chute collar relative to the discharge tube.

12. The lawnmower of claim 11, wherein the guide track defines a negative channel within which the collar tab is received.

13. The lawnmower of claim 12, wherein the negative channel is formed by the exterior surface.

14. The lawnmower of claim 12, wherein the chute collar further comprises a track collar disposed on the exterior surface, the track collar defining the negative channel.

15. The lawnmower of claim 12, wherein the collar tab extends radially inward from the sleeve body within the negative channel.

16. The lawnmower of claim 11, wherein the guide track comprises a positive rib extending radially upward from the exterior surface.

17. The lawnmower of claim 16, wherein the collar tab extends axially from the sleeve body for engagement with the positive rib.

18. The lawnmower of claim 17, wherein the collar tab cups the positive rib therein and on top of the guide track.

19. The lawnmower of claim 11, wherein the chute collar is slidably received on the discharge tube.

20. A lawnmower comprising:
a frame;
a walking element coupled to the frame;
a propulsion motor selectively powering the walking element;
a mower deck mounted to the frame;
a cutting blade rotatably mounted within the mower deck;
a bagger supported on the frame apart from the mower deck, the bagger defining a collection chamber downstream from the mower deck;
a discharge tube in fluid communication between the mower deck and the bagger and defining a tube passage to direct clippings from the mower deck to the bagger, the discharge tube comprising a separable flexible portion and rigid portion, wherein the separable rigid portion is disposed upstream from the separable flexible portion; and
a chute collar disposed on the flexible portion of the discharge tube, the chute collar comprising
a sleeve body extending circumferentially about at least a portion of the discharge tube to restrict circumferential movement of the chute collar relative to the discharge tube, and
a hand grip extending outward from the sleeve body.
